(19) United States
(12) Patent Application Publication
(10) Pub. No.: US 2023/0141019 A1
(43) Pub. Date: May 11, 2023

(54) Attention Tracking of a Crowd

(71) Applicants: Marthinus Smuts du Pre Le Roux, Durbanville Hills (ZA); Edward James Taylor, Melkbosstrand (ZA)

(72) Inventors: Marthinus Smuts du Pre Le Roux, Durbanville Hills (ZA); Edward James Taylor, Melkbosstrand (ZA)

(21) Appl. No.: 17/523,043

(22) Filed: Nov. 10, 2021

(51) Int. Cl. G06Q 30/02; G06T 7/70

(52) U.S. Cl. CPC G06Q 30/0245; G06T 7/70; G06T 2207/30196

(57) ABSTRACT

A method and system are provided for attention tracking of a crowd. The method includes: receiving captured images of at least a subset of a crowd at a live activity at multiple defined points in time; determining the orientation of at least some of the heads in the captured images; and classifying at least some of the heads in the captured images as having a gaze direction towards one of multiple defined areas of interest based on the orientation of each head. The method includes receiving timestamped data of events during the live activity from other sources; and displaying analysis of the classifications over time in combination with the events.

### FIELD OF THE INVENTION

This invention relates to image analysis, and more specifically to attention tracking of a crowd of people.

### BACKGROUND TO THE INVENTION

A modern sports venue is an extremely busy place with lots of different sensory cues battling for the attention of the attendees. A sports venue typically has a pitch or playing area where live sporting activity takes place. There is often a big screen showing live camera footage of the playing area from different cameras as well as showing playbacks of periods of play and advertisements from sponsors or other organizations. In addition, most attendees have their own mobile devices such as smartphones or tablets that may provide additional commentary and clips as well as social media and other interactions that the attendees may engage in during a game.

Similar scenarios occur in other non-sporting venues such as a concert or other performance. In a concert, there is usually a stage and a big screen above the stage providing close-up images. The concert attendees may also have mobile devices for interacting with other people during the concert.

Analysis of attendees’ attention is useful for many parties. In particular, it is useful for the big screen content providers to determine the audience’s engagement with their content.

The preceding discussion of the background to the invention is intended only to facilitate an understanding of the present invention. It should be appreciated that the discussion is not an acknowledgment or admission that any of the material referred to was part of the common general knowledge in the art as at the priority date of the application.

### SUMMARY OF THE INVENTION

According to an aspect of the present invention there is provided a computer-implemented method for attention tracking of a crowd, comprising: receiving captured images of at least a subset of a crowd at a live activity at multiple defined points in time with the captured images including heads of members of the crowd; determining the orientation of at least some of the heads in the captured images; classifying at least some of the heads in the captured images as having a gaze direction towards one of multiple defined areas of interest based on the orientation of each head; receiving timestamped data of events during the live activity from other sources; and displaying analysis of the classifications over time in combination with the events.

The method may include selecting a subset of a crowd at a venue based on a position of the subset in relation to the areas of interest. The captured images may be captured by a camera at least 30 meters away from members of the crowd to capture the subset of the crowd including at least 100 heads of members of the crowd to provide a sample of the crowd.

Determining the orientation of at least some of the heads may determine at least a pitch and a yaw of a head and, optionally, also the roll. Classifying at least some of the heads may fit determined orientation variables of a head to defined ranges of orientation variables for each area of interest. The orientation variables may be a pitch and/or a yaw. The define ranges may be statistical ranges generated from manually defined orientation variables of head samples in an image. The method may include validating the defined orientation variables by confirming that heads are not classified in more than one classification.

Displaying analysis of the classifications over time in combination with the events may display the data in a format allowing querying for specific times and/or specific events. The method may include analyzing a proportion of heads looking at each area of interest over time in relation to specific events. The method may include identifying an event time period and obtaining an average of the head classifications obtained for the time period.

The multiple defined points in time of the image capture may be at a configured frequency during the live action.

According to another aspect of the present invention there is provided a system for attention tracking of a crowd, including a memory for storing computer-readable program code and a processor for executing the computer-readable program code, the system comprising: an image receiving component for receiving captured images of at least a subset of a crowd at a live activity at multiple defined points in time with the captured images including heads of members of the crowd; an orientation determining component for determining the orientation of at least some of the heads in the captured images; a head classification component for classifying at least some of the heads in the captured images as having a gaze direction towards one of multiple defined areas of interest based on the orientation of each head; an event data component for receiving timestamped data of events during the live activity from other sources; and a displaying component for displaying analysis of the classifications over time in combination with the events.

The system may include a crowd selecting component for selecting a subset of a crowd at a venue based on a position of the subset in relation to the areas of interest.

The head classifying component may fit determined orientation variables of a head to defined ranges of orientation variables for each area of interest. The defined ranges may be statistical ranges are generated from training data analysis.

The orientation determining component may determine orientation variable of at least a pitch and/or a yaw of a head. The head classifying component may include classifying heads in an undefined classification where the orientation variables of a head do not fit in the statistical ranges.

The displaying component may display the data in a format allowing querying for specific times and/or specific events. The system may include an event analyzing component for analyzing a proportion of heads looking at each area of interest over time in relation to specific events. The event analyzing component may identify an event time period and obtains an average of the head classifications obtained for the time period.

The system may include a data capture controller component for controlling a high resolution image capturing component for capture of the images of the crowd in high resolution. The system may include a high resolution capturing component integrated into the system. The system may include an event capture component for receiving event data from other sources.

According to a further aspect of the present invention there is provided a computer program product for attention tracking of a crowd, the computer program product comprising a computer readable storage medium having stored program instructions, the program instructions executable by a processor to cause the processor to: receive captured images of at least a subset of a crowd at a live activity at multiple defined points in time with the captured images including heads of members of the crowd; determine the orientation of at least some of the heads in the captured images; classify at least some of the heads in the captured images as having a gaze direction towards one of multiple defined areas of interest based on the orientation of each head; receive timestamped data of events during the live activity from other sources; and display analysis of the classifications over time in combination with the events.

Further features provide for the computer-readable medium to be a non-transitory computer-readable medium and for the computer-readable program code to be executable by a processing circuit.

Embodiments of the invention will now be described, by way of example only, with reference to the accompanying drawings.

### BRIEF DESCRIPTION OF THE DRAWINGS

In the drawings:

FIG. 1A is a schematic diagram showing a venue for a live activity in which the described technology may be implemented;

FIG. 1B is an illustration of the result of an aspect of the described technology;

FIG. 2 is a flow diagram of an example embodiment of a method in accordance with the described technology;

FIG. 3A is a diagram showing individual people’s heads as extracted from a captured image and analyzed for orientation in accordance with an aspect of the described technology;

FIG. 3B is a graph showing ranges of head orientations with classifications in accordance with an aspect of the described technology;

FIG. 4A is a graph showing a timeline with different classifications of head orientations color coded by areas of interest in accordance with an aspect of the described technology;

FIG. 4B is a graph showing the processed results of FIG. 4A;

FIG. 4C is a graph showing the processed results of FIG. 4A;

FIG. 5 is a block diagram of an example embodiment of an attention tracking system in accordance with an aspect of the described technology; and

FIG. 6 illustrates an example of a computing device in which various aspects of the disclosure may be implemented.

### DETAILED DESCRIPTION WITH REFERENCE TO THE DRAWINGS

Attention tracking analysis of a crowd is provided by the described method and system. High resolution imagery captured by a camera over time is analyzed to determine the gaze directions of attendees in a crowd to infer an attention time line of the crowd.

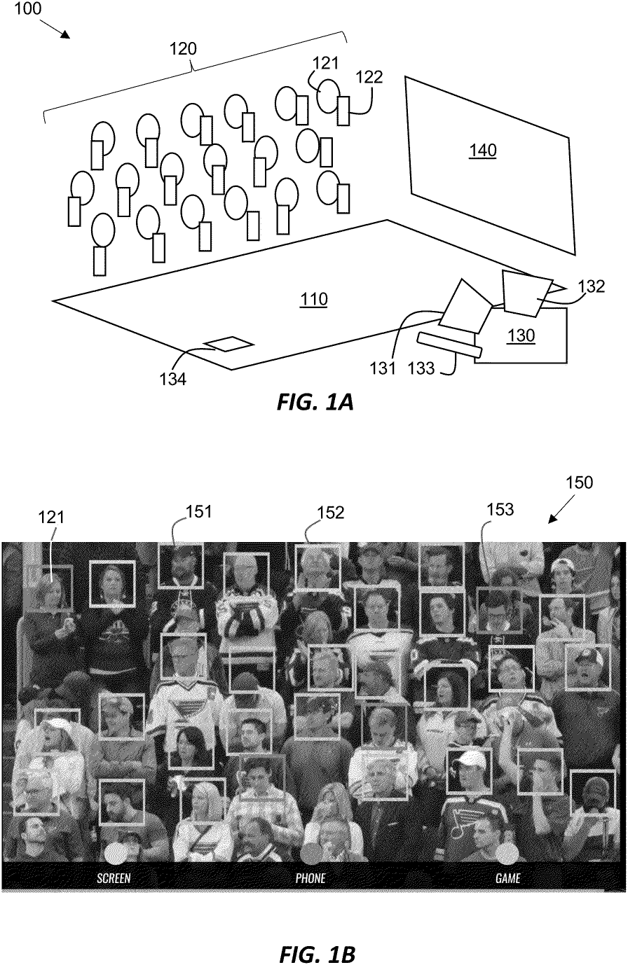

Referring to FIG. 1, a schematic diagram (100) illustrates an example embodiment of an environment in which the described method and system may be applied. An arena (110) in which live action is provided may be in the form of a sport’s playing, stage, or other arena. The arena may include one or more areas of live activity. For example, in a gymnastics or athletic competition, there may be more than one area of competition taking place simultaneously in an arena (110).

A screen (140) may display a stream of entertainment or information before, after, and during the live action as well as during any intermissions. The screen (140) may display camera feeds from the live action as well as other information and entertainment such as advertisements. More than one screen may be provided, including one or more big screens for all the crowd to watch. Multiple smaller screens may also be provided at each area of the crowd.

A crowd (120) may sit or stand adjacent one or more sides of the arena (110), for example, in stands or tiers of seats and/or in designated standing areas . Each member of the crowd has a head (121) that turns to look at different areas of interest over time. The areas of interest may include as examples, the arena (110) or any area within the arena, the screen (140) or a specific screen, and their own mobile device (122) usually held in their hands.

An attention tracking system (130) may be provided on a computing system local to the arena (110) or at a remote site. The attention tracking system (130) receives data from a first camera (131) for capturing images of an area of the crowd (120). A second camera (132) may be provided for capturing a stream of one or more screens (140) for providing to the attention tracking system (130); alternatively, a feed may be provided directly to the attention tracking system (130) of one or more screen streams. A microphone (133) may also be provided for capturing the sound of the live action for providing to the attention tracking system (130). Multiple field data capturing devices (134) may also be provided for capturing field data and providing this to the attention tracking system (130). The attention tracking system (130) may also receive data relating to the live activity, to activity on the screens, or other events happening in the timeline, from other sources such as third parties and their devices.

The attention tracking system (130) may gather and process the data from the various cameras and devices described above and may analyze the data to determine the gaze directions of attendees in the crowd (120). This may be carried out by the attention tracking system (130) by determining the orientation of the heads (121) of people in an area of the crowd (120) to determine the proportions of the crowd (120) which are looking at specified areas of interest (for example, the arena (110), one or more screens (140), and the peoples’ mobile devices (122)) over time. The attention tracking system (130) may overlay the timeline of the crowds’ attention focus with events from activities during the timeline, such as the live action in the arena and/or the displays on the one or more screens (140), and other activities.

FIG. 1B shows an illustration of an image (150) captured by a camera of an area of a crowd (120) with the heads (121) of people captured in the image of the crowd (120) annotated as looking at a live game (151) on a pitch, looking at a big screen (152), or looking at their mobile device (153), such as a smartphone.

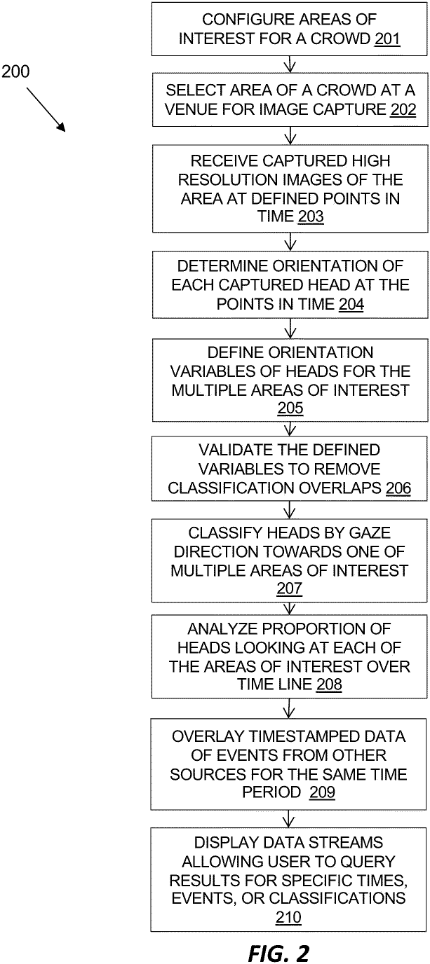

Referring to FIG. 2, a flow diagram (200) shows an example embodiment of the described method of tracking a crowd’s attention as provided by the described attention tracking system (130).

The method may configure (201) the attention tracking system (130) by determining multiple areas of interest at which a crowds’ attention may be analyzed. For example, this may be an arena, one or more screens, mobile devices of the people in the crowd, etc.

The method may select (202) an area of a crowd at a venue. This may be a subsection of the crowd that is used for analysis. An area of a crowd may be selected such that a person in the area of the crowd looking at the areas of interest must move their head significantly in different orientations (to change gaze direction). Typically, people seated in the upper sections of a venue do not need to adjust their gaze significantly to move focus and often people close to the arena do not need to look at a screen as much. The selection of the area may also be based on a number of people captured in order to be statistically representative of the whole crowd.

The method may receive (203) captured images of the area of a crowd during a time period at defined points in time. The time period may be the duration of a live activity such as a sporting fixture, a concert, etc. The images may be captured by a high resolution camera positioned to capture the selected area of the crowd. An ideal resolution may be greater than 75 pixels between the eyes of a subject. The defined points in time may be at an appropriate frequency during the time period. The images may be uploaded to a predetermined folder or bucket on a server at or accessible to the attention tracking system.

The captured images may be captured by a camera at a distance of greater than 30 meters, and often between 50 and 100 meters from the crowd. This enables a section of a crowd to be captured includes a large number of peoples’ heads, for example, at least 100 peoples’ heads. This provides an overview of the multiple peoples’ head positions for analysis. This distance capture provides crowd information as opposed to close capture that may be used for individual eye-tracking of people.

Each image may be processed to determine (204) the orientation of each head captured in the image. It may be that a selected number of the images may be processed, for example, at a lower frequency than the image capture. A selection or sample of the heads captured in the image may also be used. The images may be processed as they are received to provide a real time analysis. The processing to determine an orientation of a head may be carried out by an existing third-party computer vision algorithm. Alternatively, this may be determined by in house trained algorithms, for example, that may be specific to a particular venue. Results may be provided as simple data objects, such as a JavaScript Object Notation (JSON) file or other suitable formats. The processing may deliver pitch and yaw, and, optionally, roll values for each captured head.

The method may use the orientation of each or the selection of heads in the crowd to determine the gaze direction of each head by defining (205) orientation variables of the heads for the gaze directions towards one of the multiple defined areas of interest or another unclassified direction of “other”. For example, this may provide ranges of the orientation variables of pitch and/or yaw, and optionally roll, values for a head to classify a head as looking at each of the areas of interest. One or more of the orientation variables of pitch, yaw, and roll may have a defined range for an area of interest. For example, if a screen is above the captured section of the crowd’s heads, the pitch may be the single defining variable. In another example, if a screen is to one side of the captured section of the crowd at approximately eye level, a combination of defined ranges of the pitch and the yaw will be the defining variables.

The defining variables for the classification of gaze ranges may be determined by having human validators looking through the image and indicating which fans of a sample set are looking at the areas of interest. These results may then be grouped and analyzed to establish gaze ranges for each focal point. Isolating gaze ranges in this way simplifies the classification. The defined variable ranges may be adjusted by broadening or narrowing the defined ranges based on the crowd selection or use cases.

In an example embodiment, a sample set of heads may be evaluated by human validators to determine which heads should be classified as looking at each of the areas of interest. Statistical averages of the orientation variables of the human validator sample set are established as the defining variables for each area of interest. The defining variables may be a defined range for one or more of the pitch, roll, and yaw. The unclassified category of “other” refers to all heads that fall outside or between the defined head orientation variables. This may be due to people looking in other directions. This may also be used as an indicator of an error in calculations or hardware if a too large or too small percentage of “other” results are recorded.

The method may validate (206) the defined variable ranges by confirming that peoples’ heads are not classified in more than one class. This ensures that the gaze directions associated with specific points of interest do not overlap. This may be carried out by plotting the defined ranges of the head orientation variables in a graph for analysis. This may be carried out as a once-off validation before the individual heads are classified.

The order of the steps shown in FIG. 2, may be varied. The steps of defining orientation variables (205) and validating the defined variables (206) may be carried out at a stage before determining the orientations of all heads in captured images and classifying these. For example, sample captured images may be used by the human validators to define the orientation variables for the areas of interest before analyzing the timeline stream of captured images.

The method may classify (207) each of the heads in the captured images as being towards one of the multiple areas of interest. In one embodiment, the final gaze range is established by finding the median of the validated results of the sample set and applying a standard deviation calculation to the rest of the captured head orientations.

The method may analyze (208) the proportion of the heads in a captured image looking at each point of interest over a time period. This may be provided as a data stream imported into a dashboard for display purposes.

The method may receive timestamped data of events during the time period from other sources and may overlay (209) the timestamped data of events on the data stream of points of interest analysis of the crowd. This may provide a display (210) of the gaze classifications over time in combination with timestamped data of events in a format allowing querying for specific times and/or specific events. The format may also allow querying for time frames based on the attention data, for example, time frames for which the most or least heads were directed towards a specific area of interest. Analysis of the displayed data streams may be used to establish patterns of attention.

A specific embodiment is described in the context of a crowd of people watching a sporting game with a big screen showing live feed of the game as well as advertisements and other information. The areas of interest that are analyzed are the field of play, the big screen, and users’ mobile phones.

The attention tracker system may be used to provide a per-second analysis of in-venue crowd attention by analyzing how many people are looking at the big screen, the game, or their phones at any moment in time. The resulting data may then be used to analyze, as examples, one or more of the following: big screen content; the reach of sponsored content; ‘big screen fatigue’; mobile phone usage, the effectiveness of game day presentations, benchmarking attention of a crowd against different venues, etc.

A section of the crowd is chosen where the fans have to move their heads to look at the venue’s big screen. A high resolution digital single lens reflex (DSLR) camera or mirrorless camera may be used and focused on a subsection of the crowd (300-1000 people) to capture an image every 1 to 3 seconds.

A next step is to establish the head orientation variables (pitch, yaw, roll) that corresponds with a person looking at the screen, her phone, or the game. The captured image may be sent to computer vision analysis tools which return pitch, yaw and roll values for every head in the image. The return data allows the attention tracking system to establish how many people in this subsection of the crowd are looking at their phones, the big screen, or the game on a 1 to 3 second interval. Given the size of the image captured subset of the crowd, it can be used to establish the same for the whole venue.

A timestamped log may be kept of everything that happened on the screen and on the field during the live activity. Alternatively, an additional camera may record the screen or a feed may be provided of the screen content. Computer vision analysis tools that label content may be used to identify specific clips in the screen content. Similarly, sound may be captured during the live activity as well as on field data.

This log may be overlaid over the crowd attention timeline. This allows the analysis of when the crowd pays attention to what and this can be used to determine the return on investment for sponsors and improve the game day experience for the crowd. This will also enable standardized data when comparing different venues to each other. This may also be used as an audit tool for sponsors, for example, to see if and when their advertisement played.

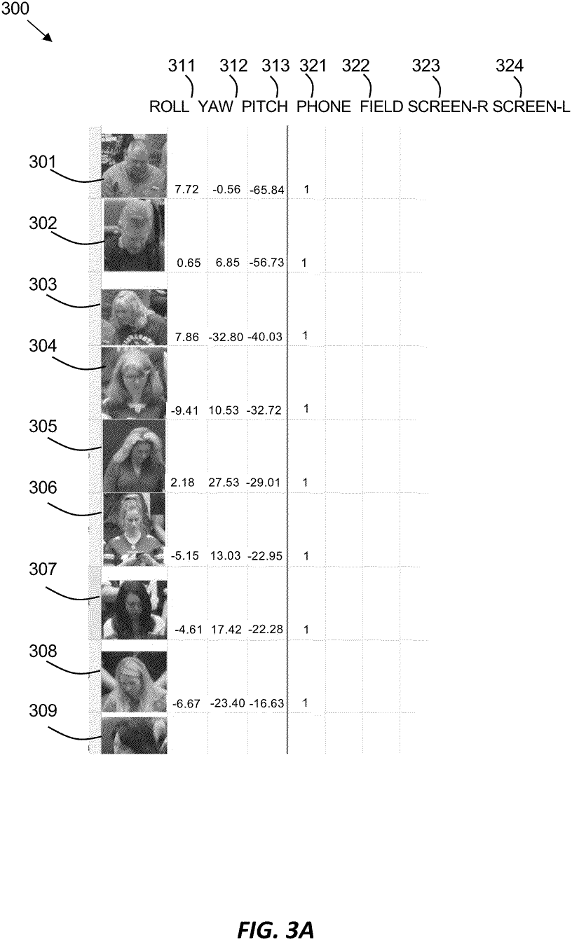

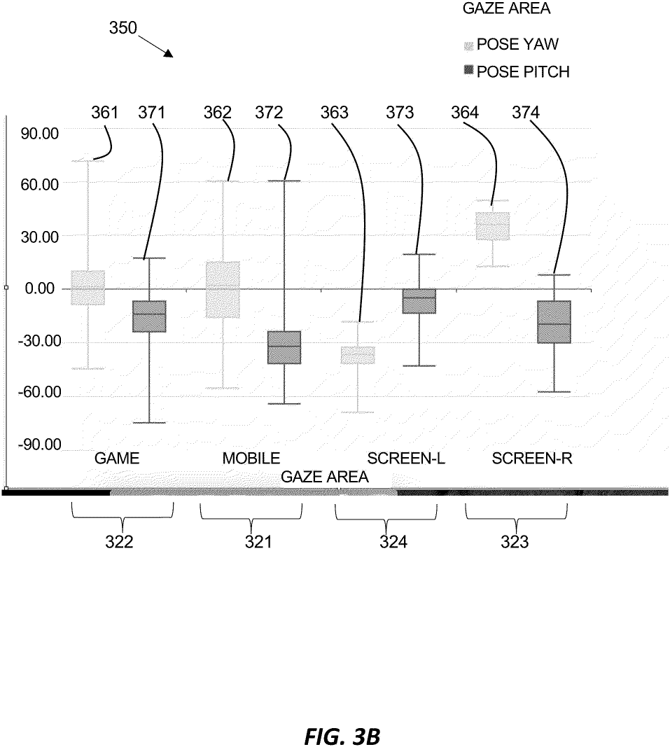

Referring to FIG. 3A, a diagram (300) shows individual people’s heads (301-309) as extracted from a captured image and analyzed for orientation in accordance with an aspect of the described method. The analysis provides values for each head (301-309) of the roll (311), yaw (312), and pitch (313). These values may be classified as indicating that the head is oriented to look at one or the areas of interest, in this example, a phone (321), the field (322), a right screen (323), or a left screen (324). In this example, all the heads (301-309) are oriented as looking down at their phones.

FIG. 3B, shows a graph (350) for validation of the classifications of head orientation variables in which the yaw (361-364) and the pitch (371-374) are shown for each of the areas of interest. In this example, the areas of interest are: a phone (321), the field (322), a right screen (323), and a left screen (324). The ranges of the pose yaw (361-364) and the pose pitch (371-374) are shown with a median value and standard deviation according to the following tables.

Table 1 shows median values for the yaw and pitch of various areas of interest.

| Gaze Area | Pose Yaw | Pose Pitch |
|---|---|---|
| Field | 1.41 | -14.02 |
| Mobile phone | 1.99 | -32.01 |
| Other | -0.59 | -19.80 |
| Screen L | -36.56 | -4.91 |
| Screen R | 36.09 | -19.59 |

Table 2 shows standard deviation values for the yaw and pitch of various areas of interest.

| Gaze Area | Pose Yaw | Pose Pitch |
|---|---|---|
| Field | 14.93 | 12.42 |
| Mobile phone | 24.89 | 19.21 |
| Other | 48.30 | 23.49 |
| Screen L | 10.21 | 13.29 |
| Screen R | 9.14 | 15.57 |

The pitch of a person’s head is the up and down movement and this is shown in the above values as the most downward movement being when a person looks at their phone.

The yaw of a person’s head is the side to side movement and this is shown in the above values where people looking at the field or their phones are looking in a generally straight direction, whilst looking at the left and right screens involves movement of the head.

The roll of a person’s head is the tilting movement which is generally not essential for the classification of areas of interest.

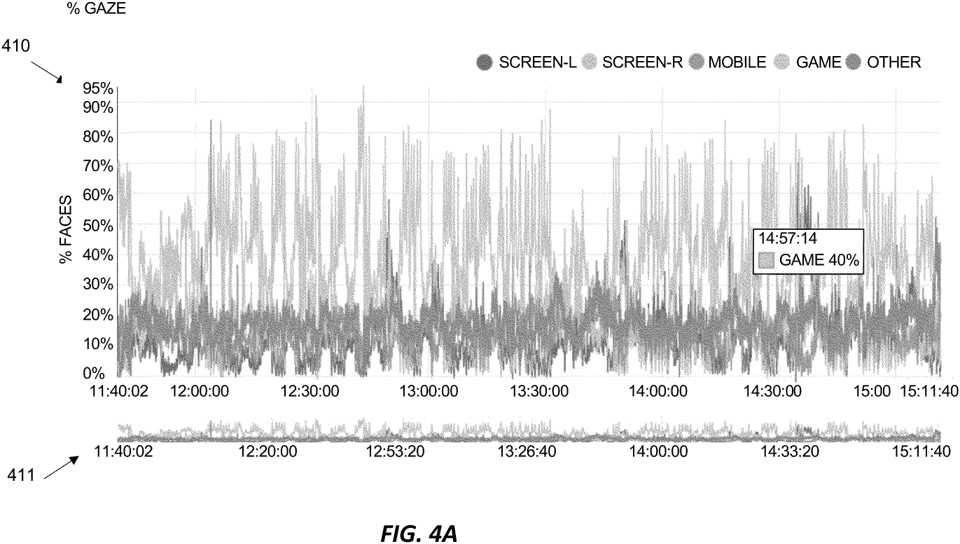

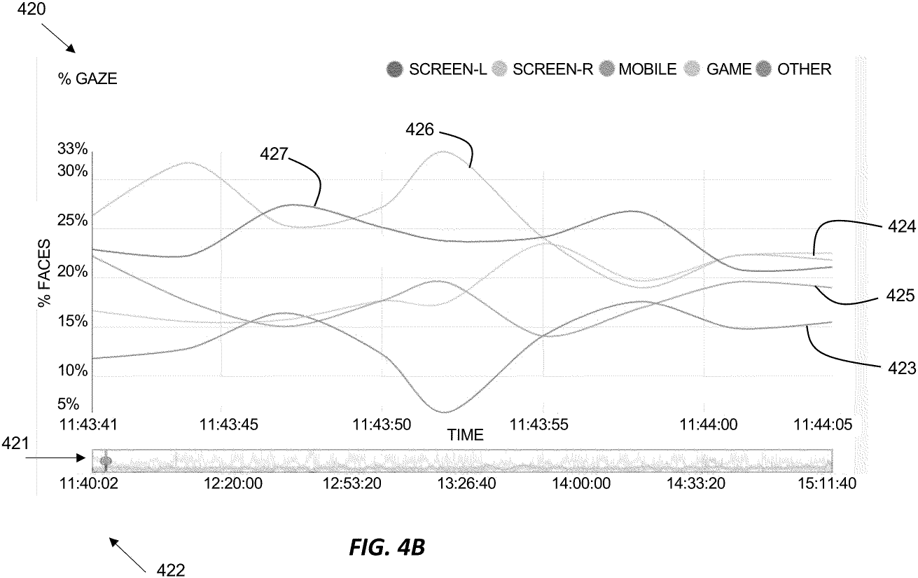

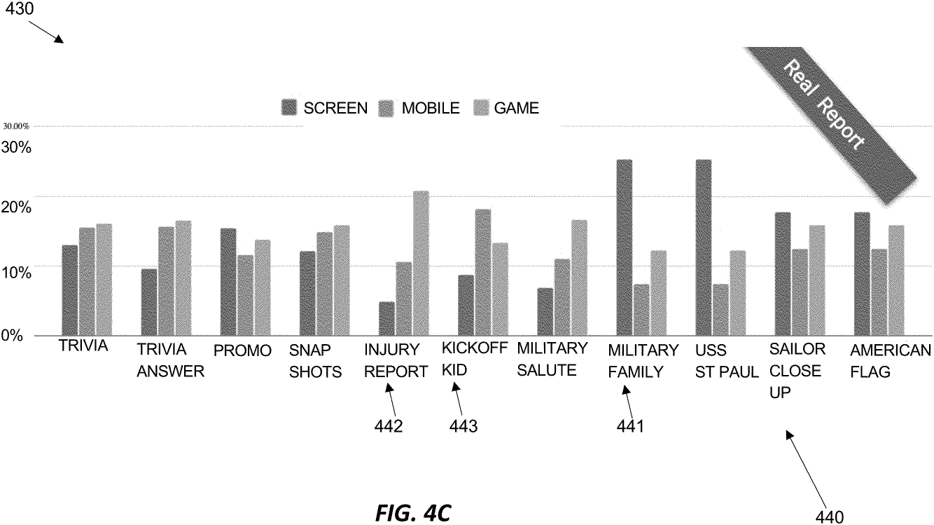

FIGS. 4A to 4C show graphs (410, 420, 430) of timelines of percentages of heads with classifications of head orientations by areas of interest.

FIG. 4A shows a graph (410) with the results of each image capture for a whole timeline (411) during an activity. The percentage of the people looking at each point of interest is shown in different colors/greyscale according to the key. Navigation tools may allow a user to enlarge the graph and focus on a shorter time range as shown in FIG. 4B.

FIG. 4B shows a graph (420) for a specific window of time (422) shown on the whole timeline (421). In this graph, the percentage of heads looking at a left screen (423), a right screen (424), a mobile phone (425), the game (426), or other (427) is shown.

FIG. 4C shows a graph report (430) with percentages of each point of interest for distinct events (440) of sponsored content during the live activity of the sports game. For an identified event, such as an advertisement on the screen, the time period of the event may be determined and the average of the head orientations obtained for the time period. Such reports may be generated by pulling data from specified time stamps, for example, when different advertisements were played. The attention data for the different advertisements may then be compared on a single graph. This may be automated for required analyses.

As an example, an immediate finding from the report may be that military-themed content outperforms all other content on the big screen as shown by event (441) which has a high screen attention percentage. This also shows that the injury report event (442) is not interesting to the crowd. The crowd were also shown to be on their phones during a product activation (443).

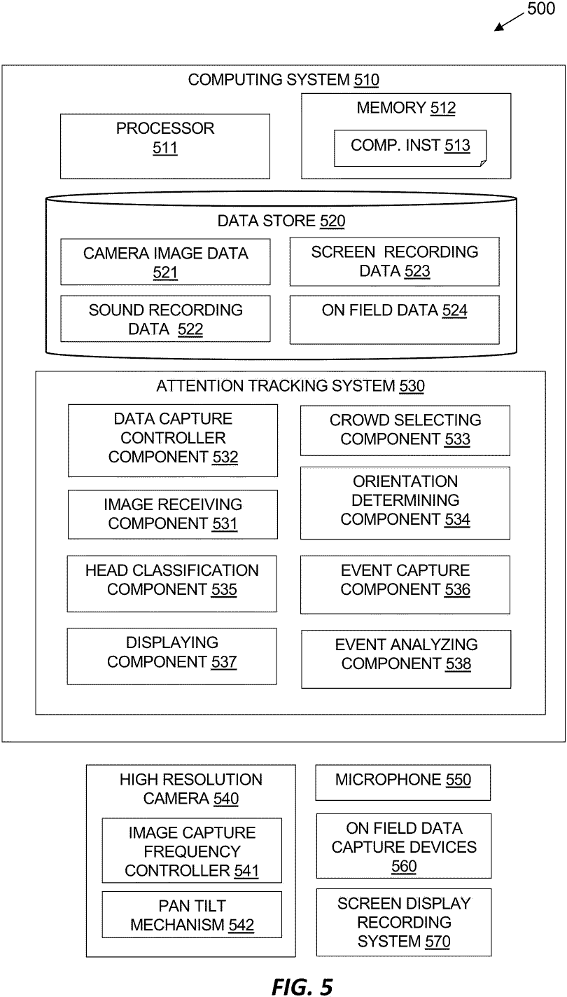

Referring to FIG. 5, a block diagram (500) shows and example embodiment the described attention tracking system (530) together with additional apparatus.

The attention tracking system (530) may be provided on a computing system (510) that may include a processor (512) for executing the functions of components described below, which may be provided by hardware or by software units executing on the computing system (510). The software units may be stored in a memory component (514) and instructions (513) may be provided to the processor (512) to carry out the functionality of the described components. In some cases, for example in a cloud computing implementation, software units arranged to manage and/or process data on behalf of the computing system (510) may be provided remotely.

The apparatus may include a first high resolution camera (540) that may include an image capture frequency controller (541) for configuring a frequency of image capture, for example, one image/second. The camera (540) may have a pan/tilt mechanism (542) for directing the camera (540) to a subsection of the crowd. The function and direction of the camera (540) may be remotely controlled by a camera controller component (531) of the attention tracking system (530). Camera image data (521) from the camera (540) may be delivered to the data store (520) for access by the attention tracking system (530). The apparatus may also include a microphone (550) for capturing sound during a live activity and delivering sound recording data (522) to the data store (520). The apparatus may also include on field data capture devices (560) to establish what is happening on the field of play by appropriate time stamped sources to provide on field data (524) to the data store (520).

The apparatus may also include a screen display recording system (570) for recording what is displayed on one or more screens. This can be sourced through a separate camera pointed at the screen and recording the feed or by importing a feed provided by the venue. Screen recording data (523) may also be provided to the data store (520).

The attention tracking system (530) may access the various forms of data from folders or buckets at the data store (520). The data may alternatively be processed in real time or may be stored at other locations.

The attention tracking system (530) may include a data capture controller component (532) for controlling a camera for capture of the images of the crowd. The attention tracking system (530) may also include a crowd selecting component (533) for selecting a subset of a crowd at a venue based on a position of the subset in relation to the areas of interest. The attention tracking system (530) may include an image receiving component (531) for receiving captured images of at least a subset of a crowd at a live activity at multiple defined points in time.

The attention tracking system (530) may include an orientation determining component (534) for determining the orientation of at least some of the heads in the captured images. The orientation determining component (534) may determine at least a pitch and a yaw of a head. The orientation determining component (534) may use a remote orientation providing component or may include local orientation determining processing.

The attention tracking system (530) may include a head classification component (535) for classifying at least some of the heads in the captured images as having a gaze direction towards one of multiple defined areas of interest based on the orientation of each head. The head classifying component (535) may fit a pitch and a yaw of a head to statistical ranges of pitch and yaw for each area of interest. The statistical ranges may be generated from training data analysis either in the form of manual range determination or automated training based on labelled training data. The head classifying component (535) may include classifying heads in an undefined classification where the pitch and yaw of a head do not fit in the statistical ranges.

The attention tracking system (530) may include an event capture component (536) for receiving event data from other sources. The event capture component (536) may include, for example, receiving a recording or live feed of the content of one or more screens during the live activity, receiving field data, and receiving live sound during the live activity.

The attention tracking system (530) may include a displaying component (537) for displaying analysis of the classifications over time in combination with the events. Data may be imported into a dashboard for display purposes where other data sources are lined up or overlayed. The displaying component (537) may display the data in a format allowing querying for specific times and/or specific events.

The attention tracking system (530) may include an event analyzing component (538) for analyzing a proportion of heads looking at each area of interest over time in relation to specific events. The event analyzing component (538) may identify an event time period and may obtain an average of the head classifications obtained for the time period. For example, an event may be the broadcasting of an advertisement on a big screen, and a duration of the advertisement may be determined and analysis carried out of the proportion of the crowd looking at the big screen during the advertisement.

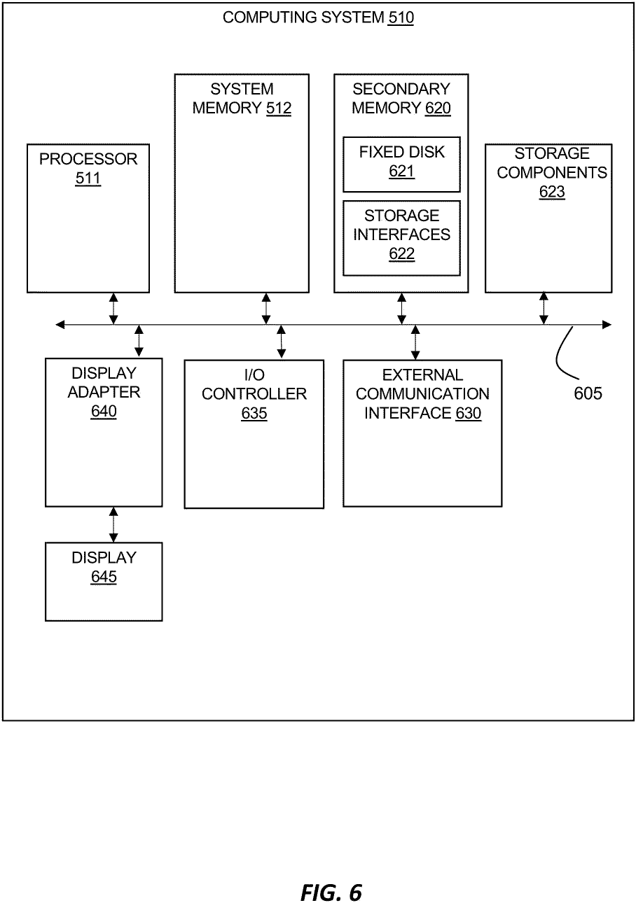

FIG. 6 illustrates an example of the computing system (510) in which various aspects of the disclosure may be implemented. The computing system (510) may be embodied as any form of data processing device including a personal computing device (e.g. laptop or desktop computer), a server computer (which may be self-contained, physically distributed over a number of locations), a client computer, or a communication device, such as a mobile phone (e.g. cellular telephone), satellite phone, tablet computer, personal digital assistant or the like. Different embodiments of the computing device may dictate the inclusion or exclusion of various components or subsystems described below.

The computing system (510) may be suitable for storing and executing computer program code. The various participants and elements in the previously described system diagrams may use any suitable number of subsystems or components of the computing system (510) to facilitate the functions described herein. The computing system (510) may include subsystems or components interconnected via a communication infrastructure (605) (for example, a communications bus, a network, etc.). The computing system (510) may include one or more processors (511) and at least one memory component in the form of computer-readable media. The one or more processors (511) may include one or more of: CPUs, graphical processing units (GPUs), microprocessors, field programmable gate arrays (FPGAs), application specific integrated circuits (ASICs) and the like. In some configurations, a number of processors may be provided and may be arranged to carry out calculations simultaneously. In some implementations various subsystems or components of the computing system (510) may be distributed over a number of physical locations (e.g. in a distributed, cluster or cloud-based computing configuration) and appropriate software units may be arranged to manage and/or process data on behalf of remote devices.

The memory components may include system memory (512), which may include read only memory (ROM) and random access memory (RAM). A basic input/output system (BIOS) may be stored in ROM. System software may be stored in the system memory (512) including operating system software. The memory components may also include secondary memory (620). The secondary memory (620) may include a fixed disk (621), such as a hard disk drive, and, optionally, one or more storage interfaces (622) for interfacing with storage components (623), such as removable storage components (e.g. magnetic tape, optical disk, flash memory drive, external hard drive, removable memory chip, etc.), network attached storage components (e.g. NAS drives), remote storage components (e.g. cloud-based storage) or the like.

The computing system (510) may include an external communications interface (630) for operation of the computing system (510) in a networked environment enabling transfer of data between multiple computing system (510) and/or the Internet. Data transferred via the external communications interface (630) may be in the form of signals, which may be electronic, electromagnetic, optical, radio, or other types of signal. The external communications interface (630) may enable communication of data between the computing system (510) and other computing devices including servers and external storage facilities. Web services may be accessible by and/or from the computing system (510) via the communications interface (630).

The external communications interface (630) may be configured for connection to wireless communication channels (e.g., a cellular telephone network, wireless local area network (e.g. using Wi-Fi™), satellite-phone network, Satellite Internet Network, etc.) and may include an associated wireless transfer element, such as an antenna and associated circuitry.

The computer-readable media in the form of the various memory components may provide storage of computer-executable instructions, data structures, program modules, software units and other data. A computer program product may be provided by a computer-readable medium having stored computer-readable program code executable by the central processor (511). A computer program product may be provided by a non-transient or non-transitory computer-readable medium, or may be provided via a signal or other transient or transitory means via the communications interface (630).

Interconnection via the communication infrastructure (605) allows the one or more processors (511) to communicate with each subsystem or component and to control the execution of instructions from the memory components, as well as the exchange of information between subsystems or components. Peripherals (such as printers, scanners, cameras, or the like) and input/output (I/O) devices (such as a mouse, touchpad, keyboard, microphone, touch-sensitive display, input buttons, speakers and the like) may couple to or be integrally formed with the computing system (510) either directly or via an I/O controller (635). One or more displays (645) (which may be touch-sensitive displays) may be coupled to or integrally formed with the computing system (510) via a display or video adapter (640).

The foregoing description has been presented for the purpose of illustration; it is not intended to be exhaustive or to limit the invention to the precise forms disclosed. Persons skilled in the relevant art can appreciate that many modifications and variations are possible in light of the above disclosure.

Any of the steps, operations, components or processes described herein may be performed or implemented with one or more hardware or software units, alone or in combination with other devices. Components or devices configured or arranged to perform described functions or operations may be so arranged or configured through computer-implemented instructions which implement or carry out the described functions, algorithms, or methods. The computer-implemented instructions may be provided by hardware or software units. In one embodiment, a software unit is implemented with a computer program product comprising a non-transient or non-transitory computer-readable medium containing computer program code, which can be executed by a processor for performing any or all of the steps, operations, or processes described. Software units or functions described in this application may be implemented as computer program code using any suitable computer language such as, for example, Java™, C++, or Perl™ using, for example, conventional or object-oriented techniques. The computer program code may be stored as a series of instructions, or commands on a non-transitory computer-readable medium, such as a random access memory (RAM), a read-only memory (ROM), a magnetic medium such as a hard-drive, or an optical medium such as a CD-ROM. Any such computer-readable medium may also reside on or within a single computational apparatus, and may be present on or within different computational apparatuses within a system or network.

Flowchart illustrations and block diagrams of methods, systems, and computer program products according to embodiments are used herein. Each block of the flowchart illustrations and/or block diagrams, and combinations of blocks in the flowchart illustrations and/or block diagrams, may provide functions which may be implemented by computer readable program instructions. In some alternative implementations, the functions identified by the blocks may take place in a different order to that shown in the flowchart illustrations.

Some portions of this description describe the embodiments of the invention in terms of algorithms and symbolic representations of operations on information. These algorithmic descriptions and representations, such as accompanying flow diagrams, are commonly used by those skilled in the data processing arts to convey the substance of their work effectively to others skilled in the art. These operations, while described functionally, computationally, or logically, are understood to be implemented by computer programs or equivalent electrical circuits, microcode, or the like. The described operations may be embodied in software, firmware, hardware, or any combinations thereof.

The language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention set forth in any accompanying claims.

Finally, throughout the specification and any accompanying claims, unless the context requires otherwise, the word ‘comprise’ or variations such as ‘comprises’ or ‘comprising’ will be understood to imply the inclusion of a stated integer or group of integers but not the exclusion of any other integer or group of integers.

1. A computer-implemented method for attention tracking of a crowd, comprising:
receiving captured images of at least a subset of a crowd at a live activity at multiple defined points in time with the captured images including heads of members of the crowd;
determining the orientation of at least some of the heads in the captured images;
classifying at least some of the heads in the captured images as having a gaze direction towards one of multiple defined areas of interest based on the orientation of each head;
receiving timestamped data of events during the live activity from other sources; and
displaying analysis of the classifications over time in combination with the events.

2. The method as claimed in claim 1, including selecting a subset of a crowd at a venue based on a position of the subset in relation to the areas of interest.

3. The method as claimed in claim 1, wherein the captured images are captured by a camera at least 30 meters away from members of the crowd to capture the subset of the crowd including at least 100 heads of members of the crowd to provide a sample of the crowd.

4. The method as claimed in claim 1, wherein classifying at least some of the heads fits determined orientation variables of a head to defined ranges of orientation variables for each area of interest.

5. The method as claimed in claim 4, wherein the defined ranges are statistical ranges generated from manually defined orientation variables of head samples in an image.

6. The method as claimed in claim 1, including validating the defined orientation variables by confirming that heads are not classified in more than one classification.

7. The method as claimed in claim 1, wherein displaying analysis of the classifications over time in combination with the events displays the data in a format allowing querying for specific times and/or specific events.

8. The method as claimed in claim 1, including analyzing a proportion of heads looking at each area of interest over time in relation to specific events.

9. The method as claimed in claim 1, including identifying an event time period and obtaining an average of the head classifications obtained for the time period.

10. The method as claimed in claim 1, wherein the multiple defined points in time of the image capture are at a configured frequency during the live action.

11. A system for attention tracking of a crowd, including a memory for storing computer-readable program code and a processor for executing the computer-readable program code, the system comprising:
an image receiving component for receiving captured images of at least a subset of a crowd at a live activity at multiple defined points in time with the captured images including heads of members of the crowd;
an orientation determining component for determining the orientation of at least some of the heads in the captured images;
a head classification component for classifying at least some of the heads in the captured images as having a gaze direction towards one of multiple defined areas of interest based on the orientation of each head;
an event data component for receiving timestamped data of events during the live activity from other sources; and
a displaying component for displaying analysis of the classifications over time in combination with the events.

12. The system as claimed in claim 11, including a crowd selecting component for selecting a subset of a crowd at a venue based on a position of the subset in relation to the areas of interest.

13. The system as claimed in claim 12, wherein the head classifying component fits determined orientation variables of a head to defined ranges of orientation variables for each area of interest.

14. The system as claimed in claim 13, wherein the head classifying component includes classifying heads in an undefined classification where the orientation variables of a head do not fit in the statistical ranges.

15. The system as claimed in claim 11, wherein the displaying component displays the data in a format allowing querying for specific times and/or specific events.

16. The system as claimed in claim 11, including an event analyzing component for analyzing a proportion of heads looking at each area of interest over time in relation to specific events.

17. The system as claimed in claim 11, including a data capture controller component for controlling a high resolution image capturing component for capture of the images of the crowd in high resolution.

18. The system as claimed in claim 11, including a high resolution image capturing component integrated into the system.

19. The system as claimed in claim 11, including an event capture component for receiving event data from other sources.

20. A computer program product for attention tracking of a crowd, the computer program product comprising a computer readable storage medium having stored program instructions, the program instructions executable by a processor to cause the processor to:
receive captured images of at least a subset of a crowd at a live activity at multiple defined points in time with the captured images including heads of members of the crowd;
determine the orientation of at least some of the heads in the captured images;
classify at least some of the heads in the captured images as having a gaze direction towards one of multiple defined areas of interest based on the orientation of each head;
receive timestamped data of events during the live activity from other sources; and
display analysis of the classifications over time in combination with the events.
